(19) United States
(12) Patent Application Publication
(10) Pub. No.: US 2004/0175577 A1
(43) Pub. Date: Sep. 9, 2004

(54) Structure of a light-incidence electrode of an optical interference display plate

(75) Inventors: Wen-Jian Lin, Hsinchu City (TW); Hsiung-Kuang Tsai, Taipei City (TW)

Correspondence Address: SUGHRUE MION, PLLC, 2100 PENNSYLVANIA AVENUE, N.W., SUITE 800, WASHINGTON, DC, 20037, US

(73) Assignee: PRIME VIEW INTERNATIONAL CO., LTD.

(21) Appl. No.: 10/670,737

(22) Filed: Sep. 26, 2003

(30) Foreign Application Priority Data
Mar. 5, 2003 (TW) 92104724

(51) Int. Cl. B32B 17/06

(52) U.S. Cl. 428/432

(57) ABSTRACT

An optical interference display plate at least comprises a light-incidence electrode and a light-reflection electrode. The light-incidence electrode at least comprises an absorption layer and a dielectric layer. A material of the absorption layer does not comprises metallic material.

### BACKGROUND OF THE INVENTION

1. Field of Invention

The present invention relates to an optical interference display. More particularly, the present invention relates to the color changeable pixel of an optical interference display.

2. Description of Related Art

Due to the properties of being light and small in size, a display plate is favorable in the market of the portable display and displays with space limits. To date, in addition to Liquid Crystal Display (LCD), Organic Electro-Luminescent Display (OLED) and Plasma Display Panel (PDP), a module of the optical interference display has been investigated.

Referring to U.S. Pat. No. 5,835,255, an array of modulation of the visible light which can be used in a display plate has been revealed. FIG. 1 shows a cross-section view of a modulation known to the art. Every modulation 100 comprises two walls, 102 and 104. These two walls are supported by post 106, and a cavity 108 is subsequently formed. The distance between these two walls, that is, the length of cavity 108, is D. Wall 102 with an absorption factor is a semi-transparent layer which absorbs visible light partially. Wall 104 is a light reflective layer which is deformable when the voltage is applied. Wall 102 comprises substrates 1021, a light absorption layer 1022 and a dielectric layer 1023. When the incident light goes through wall 102 or 104 and arrives at cavity 108, only the visible light with the wavelength corresponding to the formula 1.1 is able to be output, that is,

2D=Nλ (1.1),

wherein N is a natural number.

When the length of cavity 108, D, equals half of the wavelength times any natural number, a constructive interference is produced and a sharp light wave is emitted. At the mean time, if the observer follows the direction of the incident light, a reflective light with wavelength λ1 can be observed. Therefore, modulation 100 is “opened”.

FIG. 2 shows a cross-section view of a modulation after a voltage is applied. As shown in FIG. 2, because of the voltage wall 104 is deformed and falls down towards wall 102. The distance between wall 102 and 104, that is, the length of cavity 108 is not exactly zero. It is d, and d can be zero. If we used d instead of D in formula 1.1, only the visible light with a wavelength fulfilling formula 1.1, which is λ2, is able to produce a constructive interference and goes through. Due to the high absorption rate of wall 102 for light with wavelength λ2, all the incident visible light would be filtered, therefore the observer who follows the direction of the incident light is not able to observe any reflected visible light. The modulation is now “closed”.

A display panel with an array of modulations requires low energy, has short response time and is bi-stable. It is practical for the application in a display plate, especially for portable products, such as mobile phones, PDA and portable computers.

### SUMMARY OF THE INVENTION

The prior manufacturing method for manufacture modulation has a few problems. The quality of the products is often not stable and the yield is not high. The difficulties raise with increasing size of the plate. The critical matter is the light-incidence electrode (wall 102 of the prior art modulation). A light incidence electrode comprises substrate, an absorption layer and a dielectric layer. The absorption layer is made from metal which is thinner than 100 angstroms. The reason to use metals is that if the metal layer is thin enough it is semi-transparent. Therefore, to have a control of the thinness of a metal layer, for example, less than 100 angstroms, is essential. It is not difficult to form a metal layer which is thinner than 100 angstroms. It can be achieved by physical vapor deposition and sputtering methods. Nevertheless, it is difficult to form a metal layer with uniform thickness and stable characteristic. Due to the difficulty, the quality of the prior art modulation is usually not stable and the yield of the manufacturing process is low. This invention provides a new material and a new structure of the absorption layer, which can be used to solve the problems.

One objective of the present invention is to provide an optical interference display in which a new material is used to form the absorption layer. The quality of the optical interference display is stable and the yield of the manufacturing process is high.

The second objective of the present invention is also to provide an optical interference display with a non-metal absorption layer. The quality of the optical interference display is stable and the yield of the manufacturing process is high.

The third objective of the present invention is also to provide an optical interference display with a non-metal multi-layered absorption layer. The quality of the optical interference display is stable and the yield of the manufacturing process is high.

According to the purposes of the present invention to change the materials and the structure of the absorption layer as mentioned in the aims of the present invention, a modulation used in an optical interference display is provided in the first embodiment. This modulation comprises at least a light-incidence electrode and a light-reflection electrode. The light-incidence electrode comprises a substrate and a dielectric layer. The substrate is a conductive transparent layer with lower transparency rate (or higher absorbency rate) than the well-known metal absorption layer. The thinness of the conductive substrate or the content of impurities of the conductive substrate can be increased to decrease the transparency.

According to the purposes of the present invention, the second embodiment discloses a modulation used in an optical interference display. This modulation comprises at least a light-incidence electrode and a light-reflection electrode, and the light-incidence electrode comprises the substrate, an absorption layer and a dielectric layer. The substrate is the first conductive transparent layer. The first dielectric layer is formed on the first conductive transparent layer, eg. substrate, and the second conductive transparent layer is then formed on the first dielectric layer by sputtering. Subsequently the second dielectric layer is deposited on the second conductive layer. The absorption layer comprises the first dielectric layer and the second conductive transparent layer. The light is actually absorbed by the first (substrate) and the second conductive transparent layer, wherein axes of the first conductive transparent and the axes and lattice of the second conductive transparent layer could be different.

According to the objectives of the present invention, the third embodiment provides a modulation used in an optical interference display. This modulation comprises at least a light-incidence electrode and a light-reflection electrode, and the light-incidence electrode comprises a substrate, an absorption layer and a dielectric layer. The substrate is the first conductive transparent layer. On top of the substrate, at least two dielectric layers and two conductive transparent layers are formed in turns. The absorption layer comprised all layers apart from the dielectric layer on the top and the substrate. The light is actually absorbed by the substrate and the conductive transparent layers, wherein the axes and lattice of axes of every neighboring conductive transparent layer could be different.

Based on the modulation revealed herein, the absorption layer is not made from the well-known thin metal layer (less than 100 angstroms) because of the difficulties of forming a uniform ultra-thin metal layer. In the present invention, an absorption layer is made from metal oxide or a multi-layer comprising conductive metal oxide layers and other dielectric layers. Since the light transparent rate of conductive metal oxide layers and of dielectric materials are higher than the transparent rate of metals, the multi-layer, which is usually thicker than 300 angstroms, is supposed thicker than the metal layers known to the art. The usage of the multi-layer comprising conductive metal oxide layers and other dielectric layers provides some advantages: firstly the quality is better and the manufacturing is more stable, especially when a larger plate is related in the manufacturing process; and secondly, because a thick layer of metal oxides is used, it can function as both a conductive layer and a absorption layer. It is not necessary to produce an extra conductive layer.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross-section view of a prior art modulation.

FIG. 2 is a cross-section view of a prior art modulation after a voltage is applied.

FIG. 3 is a cross-section view of the modulation according to one preferred embodiment of the present invention.

FIG. 4 is a cross-section view of the light-incident electrode of a modulation according to one preferred embodiment of the present invention.

FIG. 5 is a cross-section view of the light-incident electrode of the modulation according to another preferred embodiment of the present invention.

FIG. 6 is a cross-section view of the light-incident electrode of the modulation disclosed in the third embodiment of the present invention according to one preferred embodiment of the present invention.

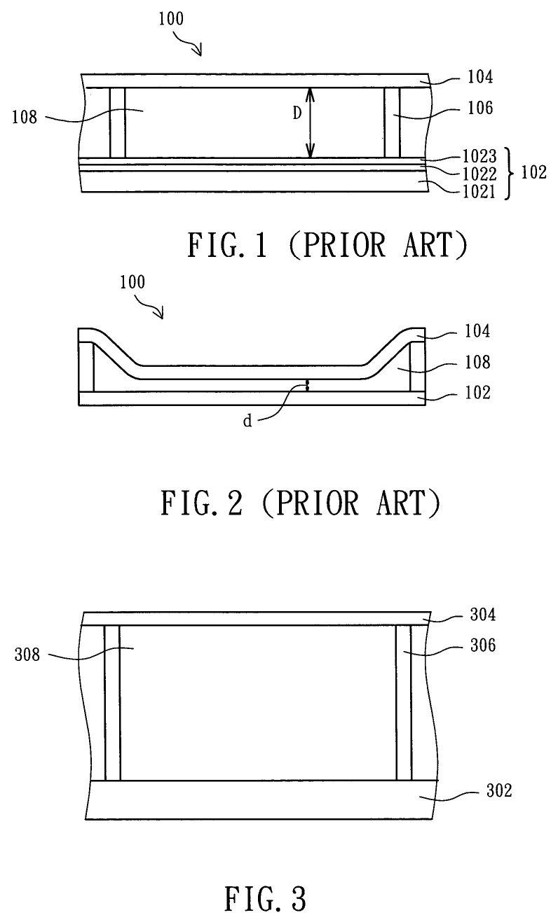

### DESCRIPTION OF THE PREFERRED EMBODIMENTS

In order to provide further information of the structure of an optical interference display, three examples are provided herein to explain the structure of the light incidence electrode of every modulation in the present invention.

### EMBODIMENT 1

Please refer to FIG. 3. FIG. 3 shows a cross-section view of the modulation disclosed in the first embodiment of the present invention. The modulation 303 comprises at least a light-incidence electrode 302 and a light reflection electrode 304. The light incidence electrode 302 and the light reflection electrode 304 are settled in parallel. These two electrodes are supported by posts 308, and a cavity 310 is then formed. The light incidence electrode 302 and the light reflection electrode 304 are selected from the group consisting of narrowband mirror, broadband mirror, non-metal mirror, metal mirror and the combination thereof.

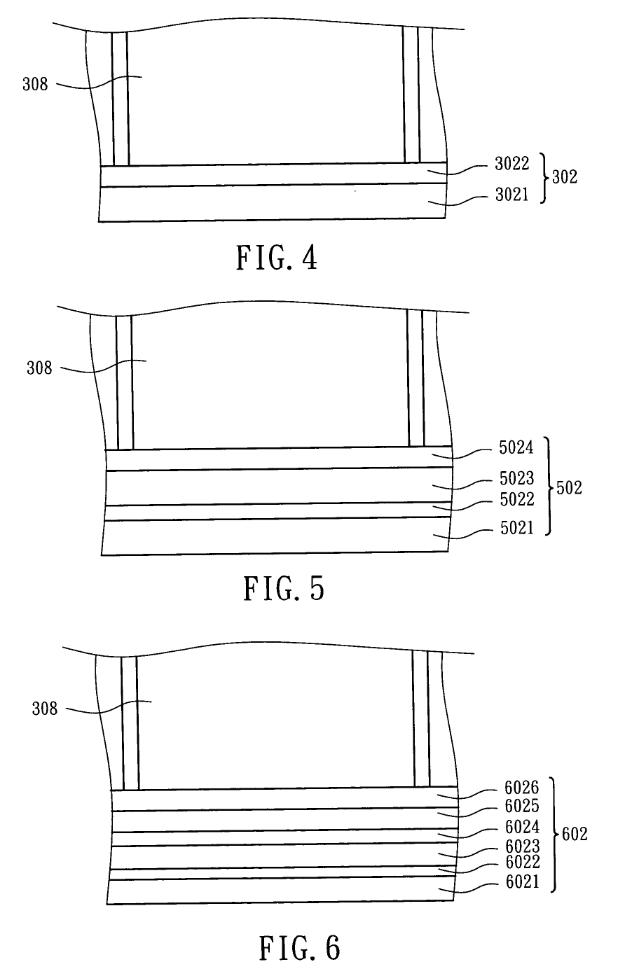

Referring is made to FIG. 4, FIG. 4 shows a cross-section view of the light-incidence electrode of the modulation disclosed in the first embodiment of the present invention. Light-incidence electrode 302 is a semi-transparent electrode which comprises a substrate 3021 and a dielectric layer 3022. When the incident light goes through light-incidence electrode 302, part of the light is absorbed by light-incidence electrode 302. Substrate 3021 is made from a conductive transparent material, for example, ITO, IZO, ZO, IO and the combination thereof. The material used for forming dielectric layer 3022 is silicon oxide, silicon nitride or metal oxide.

The transparency of the conductive transparent material is normally high, that is, more than 80%; while the ideal transparency of light incidence electrode 302 is between about between 20% and 70%. The method of decreasing the transparency of substrate 3021 comprises increasing the thickness of the substrate 3021, adjusting the manufacturing parameters to decrease the purity of the substrates and so on. The thicker the substrate is, the lower the transparency that can be achieved. Therefore, increasing the thickness of the substrate decreases the transparency. Moreover, adjusting the manufacturing parameters to produce a substrate with disordered lattice makes various axes in every part of the substrate is another method to decrease the transparency of the substrate. Furthermore, in order to decrease the transparency of substrate, a low purity substrate can be made by increasing the impurities in the substrate (more than 100 ppm). It disorders the lattice of the substrate. Also, the impurities in the substrates normally have low transparency. It helps to decrease the overall transparency as well. The three methods discussed herein can be either used alone, or in combination.

### EMBODIMENT 2

Referring is made to FIG. 5, FIG. 5 shows a cross-section view of the light incidence electrode of the modulation disclosed in the second embodiment. Similar to light incidence electrode 302 of modulation 300 in FIG. 3, light incidence electrode 502 comprises a substrate 5021, one first dielectric layer 5022, one conductive transparent layer 5023 and one second dielectric layer 5024. Incident light going through light incidence electrode 502 is partially absorbed. The substrate 5021 and the conductive transparent layer 5023 are made from a conductive transparent material, such as ITO, IZO, ZO and IO. The dielectric layer 5022 is made from silicon oxide, silicon nitrite or metal oxide.

The substrate 5021 and the conductive transparent layer 5023 function as an absorption layer. However, the substrate is formed on a glass plate (not shown in the figure) and the conductive transparent layer is formed on the top of the dielectric layer 5022. The lattice is disordered and the axes of each are different. Therefore, the transparent rate of the absorption layer can be similar to the transparent rate of a well-known absorption layer.

The transparency of the conductive transparent layer decreased by decreasing the purity of the substrate, too.

### EMBODIMENT 3

Please refer to FIG. 6. FIG. 6 shows the cross-section view of the modulation disclosed in the third embodiment of the present invention. As light incidence electrode 302 of modulation 300, the light incidence electrode 602 is a semi-transparent electrode which comprises a substrate 6021, one first dielectric layer 6022, one first conductive transparent layer 6023, one second dielectric layer 6024, one second conductive transparent layer 6025 and one third dielectric layer 6026. When the incident light goes through light-incidence electrode 602, part of the light is absorbed. Substrate 6021 and the two conductive transparent layers 6023 and 6025 are made from a conductive transparent material, for example, ITO, IZO, ZO, IO and the combination thereof. The material for forming dielectric layer 6022 is silicon oxide, silicon nitride or metal oxide.

Substrate 6021, the first conductive transparent layer 6023 and the second conductive transparent layer 6025 function as an absorption layer. The first dielectric layer 6022 formed on the substrate 6021 influences the formation of the first conductive transparent layer 6023. The lattice is therefore disordered. Also, the lattice of the second dielectric layer 6024 and the first dielectric layer 6022 are different because of the different condition during deposition. And the lattice of the second conductive transparent layer 6025 is different from the ones in the first dielectric layer 6023 and substrate 6021. The formation of the lattice and axes of ever part of the conductive transparent layer are all different. Further, the formation of multilayer can also increase the thinness of an absorption layer. Therefore the transparency of the absorption layer can be the same as the transparency of a well-known absorption layer.

Here the transparency of the conductive transparent layer decreased by decreasing the purity of the substrate as well.

The numbers of the layers are not limited. The aim of the present invention is to provide a multi-layered absorption layer made from metal oxide and the combination of metal oxide and dielectric materials instead of ultra-thin metal. The quality of the absorption layer and the stability of the manufacturing process are both improved.

It will be apparent to those skilled in the art that various modifications and variations can be made to the structure of the present invention without departing from the scope or spirit of the invention. In view of the foregoing, it is intended that the present invention cover modifications and variations of the present invention provided they fall within the scope of the following claims and their equivalents.

What is claimed is:

1. An optical interference display, at least comprising:
a conductive transparent layer; and
a dielectric layer located on the conductive transparent layer, wherein a incident light irradiate form a side of the conductive transparent layer, the material of the conductive transparent layer and a thickness of the conductive transparent layer absorb at least 30% of the incident light.

2. The optical interference display of claim 1, wherein a material of the conductive transparent layer is selected from the group consisting of ITO, IZO, ZO, IO and the combination thereof.

3. The optical interference display of claim 1, wherein a material of the dielectric layer comprises silicon oxide, silicon nitride or metal oxide.

4. The optical interference display of claim 1, wherein lattice of the conductive transparent layer is disordered.

5. The optical interference display of claim 1, wherein axes of every part of the conductive transparent layer are different.

6. The optical interference display of claim 1, wherein the conductive transparent layer further comprises more than 100 ppm impurity.

7. An optical interference display plate, at least comprising:
two conductive transparent layers; and
two dielectric layers, each of the dielectric layers located on each of the conductive transparent layers, wherein a incident light irradiate form a side of the conductive transparent layer, the material of the conductive transparent layer and a thickness of the conductive transparent layer absorb at least 30% of the incident light.

8. The optical interference display of claim 7, wherein a material of the conductive transparent layer is selected from the group consisting of ITO, IZO, ZO, IO and the combination thereof.

9. The optical interference display of claim 7, wherein a material of the dielectric layer comprises silicon oxide, silicon nitride or metal oxide.

10. The optical interference display of claim 7, wherein lattice of the conductive transparent layer is disordered.

11. The optical interference display of claim 7, wherein axes of every part of the conductive transparent layer are different.

12. The structure of claim 7, wherein the conductive transparent layer further comprises more than 100 ppm impurity.

13. An optical interference display plate, at least comprising:
a first conductive transparent layer;
a first dielectric layer located on the first conductive transparent layer;
a second conductive transparent layer located on the first dielectric layer;
a second dielectric layer located on the second conductive transparent layer;
a third conductive transparent layer located on the second dielectric layer; and
a third dielectric layer located on the third conductive transparent layer,
wherein a incident light irradiate form a side of the first conductive transparent layer, the material of the first conductive transparent layer, the second conductive transparent layer, the third conductive transparent layer and a thickness of the first conductive transparent layer, the second conductive transparent layer, the third conductive transparent layer absorb at least 30% of the incident light.

14. The optical interference display of claim 13, wherein a material of the first conductive transparent layer, the second conductive transparent layer and the third conductive transparent layer is selected from the group consisting of ITO, IZO, ZO, IO and the combination thereof.

15. The optical interference display of claim 13, wherein a material of the first dielectric layer, the second dielectric layer and the third dielectric layer comprises silicon oxide, silicon nitride or metal oxide.

16. The optical interference display of claim 13, wherein the lattice of the first conductive transparent layer and the second conductive transparent layer is different.

17. The optical interference display of claim 13, wherein the lattice of the second conductive transparent layer and the third conductive transparent layer is different.

18. The optical interference display of claim 13, wherein axis of the first conductive transparent layer and the second conductive transparent layer is different is different.

19. The optical interference display of claim 13, wherein axis of the second conductive transparent layer and the third conductive transparent layer is different is different.

20. The structure of claim 13, wherein the conductive transparent layers further comprises more than 100 ppm impurity.
